(19) United States
(12) Patent Application Publication
(10) Pub. No.: US 2004/0103659 A1
(43) Pub. Date: Jun. 3, 2004

(54) Electrical means for sensing reverse and neutral and swash plate structures therefore

(76) Inventors: Kevin L. Johnson, Douglas, GA (US); Mark E. Bruner, Paoli, IN (US); Michael D. Smith, Oxford, MI (US)

Correspondence Address: BAKER & DANIELS, 111 E. WAYNE STREET, SUITE 800, FORT WAYNE, IN, 46802

(21) Appl. No.: 10/638,514

(22) Filed: Aug. 11, 2003

Related U.S. Application Data
(60) Provisional application No. 60/402,806, filed on Aug. 12, 2002.

(51) Int. Cl. F03C 1/00

(52) U.S. Cl. 60/500

(57) ABSTRACT

A lawnmower including a frame, an engine having an electrical system and attached to the frame, the engine being started by a starter mechanism. A mower deck assembly having a rotating blade is connected to the frame with the blade being selectively engaged with the engine. A reversible transmission is driven by the engine and includes a shift mechanism having a forward, a neutral, and a reverse position, and at least one sensor for sensing the position of the shift mechanism. The sensor is capable of at least one of directing a signal to the mower deck assembly for operation and non-operation of the mower deck assembly and directing a signal to the starter circuit for prevention of start-up when the shift mechanism is not in the neutral position.

### CROSS-REFERENCE TO RELATED APPLICATION

This application claims the benefit under 35 U.S.C. §119(e) of U.S. Provisional Application No. 60/402,806, filed Aug. 12, 2002. The entire disclosure of U.S. Provisional Application No. 60/402,806, filed Aug. 12, 2002 is hereby expressly incorporated by reference herein.

### BACKGROUND

The present invention relates to transmissions intended primarily for use in the lawn and garden industry on working vehicles such as tractors, riding lawnmowers, lawn and garden implements and the like.

It is useful to provide a “neutral switch” for use with a working vehicle so that an operator is prevented from starting or activating the vehicle when the vehicle's transmission is engaged. Such a neutral switch advantageously prevents the vehicle from lurching in a forward or reverse direction on start up.

Working vehicles include potentially dangerous working devices. For example, riding mowers, including most lawn tractors and garden tractors, include potentially dangerous rotating blades which comprise part of the mower deck and may cause injury to the operator or a bystander. It is desirable to disable the rotating blades of a riding mower when the mower is moving in a reverse direction to prevent possible injury to the operator, a bystander, or nearby property.

### SUMMARY OF THE INVENTION

The invention, in one form thereof, comprises an axial piston hydrostatic transmission including a variable displacement axial piston pump, an input shaft rotatably connected to the pump, whereby rotation of the input shaft causes rotation of the pump, an axial piston motor hydraulically connected to the pump, an output shaft rotatably connected to the motor, whereby rotation of the motor causes rotation of the output shaft, a pivotable swash plate associated with the pump, whereby movement of the swash plate controls the speed and direction of the hydrostatic transmission, the swash plate movable between a forward position, a neutral position, and a reverse position, a center adjacent the swash plate, the center operable to sense the position of the swash plate, and a switch connected to the sensor, the switch movable between a closed position and an open position in response to the sensor. In one form of the present invention, the swash plate includes an exterior surface, with the center abutting the exterior surface to, advantageously, directly sense whether the transmission is in forward, neutral, or reverse.

When referring to swash plate position, a forward position of the swash plate indicates a position of the swash plate in which the vehicle driven by the hydrostatic transmission is being moved forward by the hydrostatic transmission. Similarly, a neutral position of the swash plate corresponds to a neutral condition of the vehicle driven by the hydrostatic transmission, that is, the transmission is not moving the vehicle. Finally, a reverse position of the swash plate indicates a position of the swash plate in which the vehicle driven by the hydrostatic transmission is being moved in a reverse direction by the hydrostatic transmission.

The invention, in another form thereof, comprises a gear transmission including a plurality of mechanically selectable forward gears, and mechanically selectable reverse gear, a neutral spacer, a shift key for selectively one of the plurality of forward gears on the reverse gear, a shift fork connected to the shift key, whereby movement of the shift fork causes movement of the shift key to control the speed and direction of the transmission, the shift fork movable between a forward position, a neutral position, and a reverse position, a center adjacent said shift fork, the center operable to sense the position of the shift fork, and a switch connected to the sensor, the switch movable between a closed position and an open position in response to the sensor. In one form of the present invention, the sensor abuts an exterior surface of the shift fork to, advantageously, directly sense whether the transmission is in a forward, neutral, or reverse condition.

With reference to shift fork position, a forward position of the shift fork indicates a position of the shift fork in which the vehicle driven by the transmission is being moved forward by the transmission. Similarly, a neutral position of the shift fork corresponds to a neutral condition of the vehicle driven by the transmission, that is, the transmission is not moving the vehicle. Finally, a reverse position of the shift fork indicates a position of the shift fork in which the vehicle driven by the transmission is being moved in a reverse direction by the transmission.

The aforementioned hydrostatic and gear transmissions are, in one form of the present invention, utilized in a lawnmower having a mower deck with a rotatable blade connected thereto.

The invention, in yet another form thereof, comprises a sensing and disabling system for a lawnmower to prevent operation of a mower deck assembly while in reverse and to prevent startup of the mower if not in neutral, including an engine, a transmission having a selectively entered reverse condition, a selectively entered forward condition, and a selectively entered neutral position, the transmission being selectively driven by the engine, a mower deck assembly selectively driven by said engine, a first sensor in communication with said transmission and the mower deck assembly, the first sensor preventing operation of the mower deck assembly when the first sensor senses the transmission is in the reverse condition, and a second sensor in communication with the transmission and the engine, the second sensor preventing start-up of the engine when the second sensor senses the transmission is in either the forward or the reverse position.

### BRIEF DESCRIPTION OF THE DRAWINGS

The above-mentioned and other features and objects of this invention will become more apparent and the invention itself will be better understood by reference to the following description of embodiments of the invention taken in conjunction with the accompanying drawings, wherein:

FIG. 1 is a perspective view of a riding lawnmower having the inventive electrical means for sensing reverse and/or neutral feature incorporated therein;

FIG. 2 is a rear view of a manual shift transaxle including the electrical means for sensing reverse and/or neutral;

FIG. 3A is a sectional view of the transaxle of FIG. 2 along line 3A-3A thereof;

FIG. 3B is a sectional view of the transaxle of FIG. 3A along line 3B-3B thereof;

FIG. 4A is an enlarged view of the shift fork of the transaxle of FIG. 3A;

FIG. 4B is an enlarged end view of the shift fork of FIG. 3A;

FIG. 5A is a top schematic view of a transaxle having a means for sensing reverse and a means for sensing neutral in accordance with the present invention;

FIG. 5B is a side schematic view of a portion of a shift fork and the two means of FIG. 5A;

FIG. 5C is a side schematic view of an alternative arrangement of the shift fork and two means for sensing;

FIG. 6A is an exploded view of a hydrostatic transmission including the electrical means for sensing reverse and/or neutral incorporated therein;

FIG. 6B is a sectional view of a hydrostatic transaxle including the hydrostatic transmission module of FIG. 6A;

FIG. 7 is a rear cross-sectional view of the assembled hydrostatic transmission of FIG. 6A taken along line 7-7 of FIG. 6A including the electrical means for sensing reverse and neutral;

FIG. 8 is a partial fragmentary view of the hydrostatic transmission of FIG. 6 showing the swash plate and switch associated with the electrical means for sensing, as viewed from the bottom of the upper casing half;

FIG. 9A is a top perspective view of a swash plate used with the hydrostatic transmission of FIG. 6 in which the swash plate is structured for reverse sensing only;

FIG. 9B is a top view of the swash plate of FIG. 9A;

FIG. 9C is a side, partial cutaway view of the swash plate of FIG. 9A;

FIG. 10 is a perspective view of a swash plate used in accordance with the electrical means for sensing neutral;

FIG. 11A is a perspective view of a swash plate used in accordance with the electrical means for sensing reverse and neutral;

FIG. 11B is a top view of the swash plate of FIG. 11A;

FIG. 11C is a perspective view of the swash plate of FIG. 11A with two switches and two sensors in accordance with the present invention;

FIG. 12 is a bottom view of the swash plate of FIG. 9A with the sensor and switch for sensing reverse, the swash plate being positioned such that the transaxle is in the reverse position;

FIG. 13 is a bottom view of the swash plate and the switch of FIG. 12 with the swash plate being positioned in the neutral position;

FIG. 14 is a bottom view of the swash plate of FIG. 12 with the swash plate being positioned in the forward position;

FIG. 15 is an electrical schematic diagram showing the connection of the electrical means for sensing reverse and the electromagnetic clutch associated with the mower deck assembly;

FIG. 16 is an electrical schematic diagram showing two electrical means for sensing, one for reverse sensing and one for neutral sensing, being connected to the electromagnetic clutch of the mower deck assembly and the starter mechanism of the mower, respectively; and

FIG. 17 is a flow chart showing the operation of a reverse sensing switch.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended.

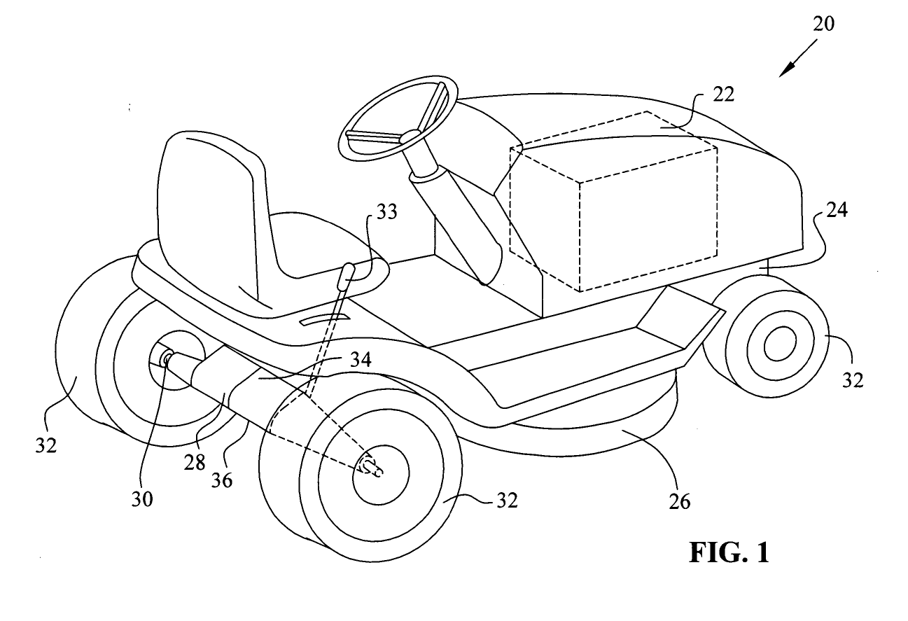

Referring first to FIG. 1, mower 20 has engine 22 mounted to frame 24 and mower deck assembly 26 mounted on the frame's underside. At the rear of mower 20 is transaxle 28 having axle 30 with ground engaging wheels 32 mounted at the ends thereof. Two ground engaging wheels 32 are also located at the front of mower 20. An operator can selectively operate transaxle 28 through manual shift lever 33 extending from transaxle 28.

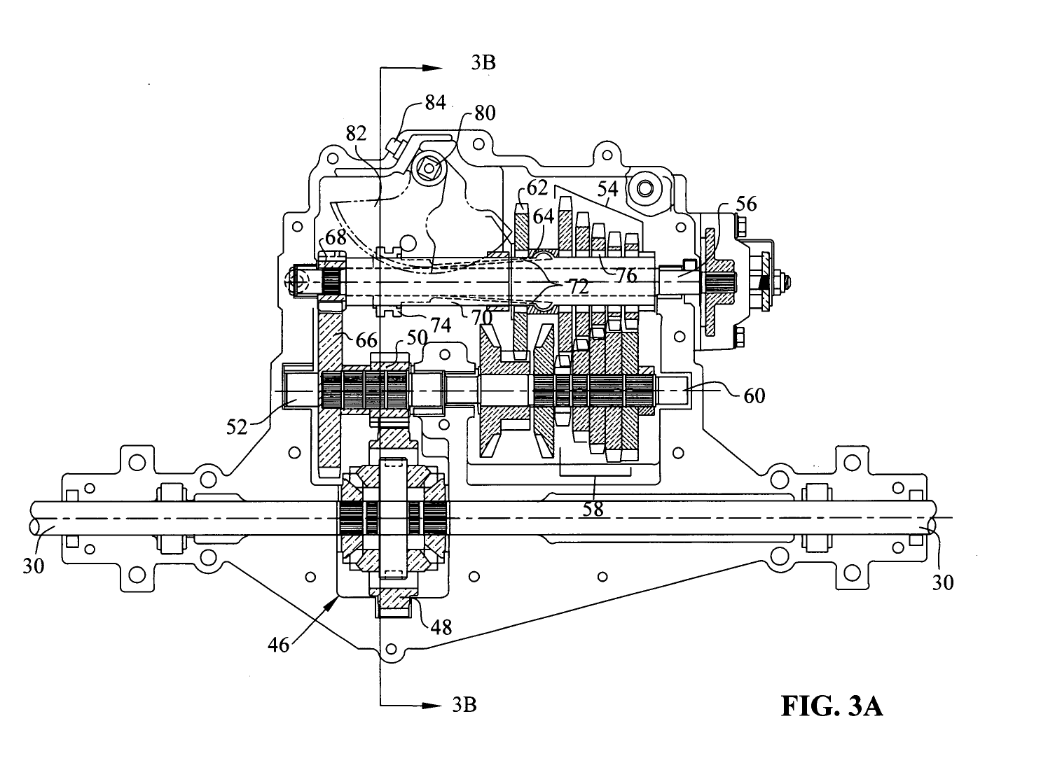

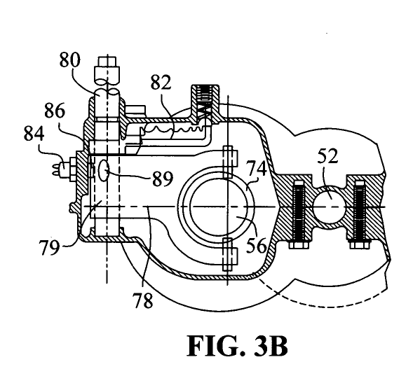

As shown in FIG. 3A, transaxle 28 includes a manual shift transmission, such as that disclosed in U.S. Pat. No. 5,287,769, issued Feb. 22, 1994, U.S. Pat. No. 4,966,574, issued Oct. 30, 1990, and U.S. Pat. No. 4,791,825, issued Dec. 20, 1998, all of which are assigned to the assignee of the present invention, the complete disclosures of which are expressly incorporated herein by reference.

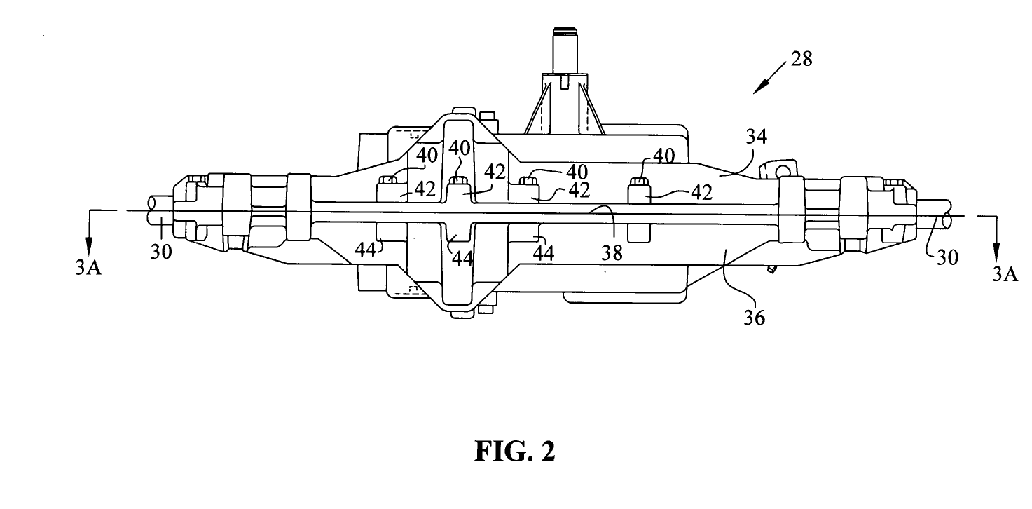

Referring now to FIG. 2, a rear exterior view of transaxle 28 is shown, with transaxle 28 having two casing halves, upper casing half 34 and lower casing half 36, which abut at horizontal interface 38. Upper casing half 34 and lower casing half 36 are joined together by bolts 40 inserted through apertures in bosses 42 on upper casing half 34, and threaded into threaded apertures of bosses 44 on lower casing half 36. As can be seen, a portion of axle 30, which is supported by the transaxle casing, extends from either end of transaxle 28 to be attached to a ground engaging wheel 32.

Transaxle 28 is shown in FIG. 3A, and further includes conventional differential mechanism 46 through which the two respective portions of axle 30 are coupled to the gear train. Ring gear 48 of differential 46 intermeshes with gear 50 mounted on shaft 52 to transfer motion from the rest of the gear train to differential 46. Within transaxle 28, output gear set 54 is rotatably disposed on shaft 56 and intermeshes with input gear set 58, comprising gears which are individually rotatably fixed onto shaft 60 via splines. Gear sets 54 and 58 each include a plurality of gears of varying diameters. One forward gear of output gear set 54 is selected through the key shift mechanism to obtain one of a plurality of forward speeds when operating mower 20. Also rotatably mounted on shaft 56 are reverse gear 62 and neutral spacer 64. Mounted on shaft 52 is gear 66 intermeshing with small gear 68 mounted on shaft 56.

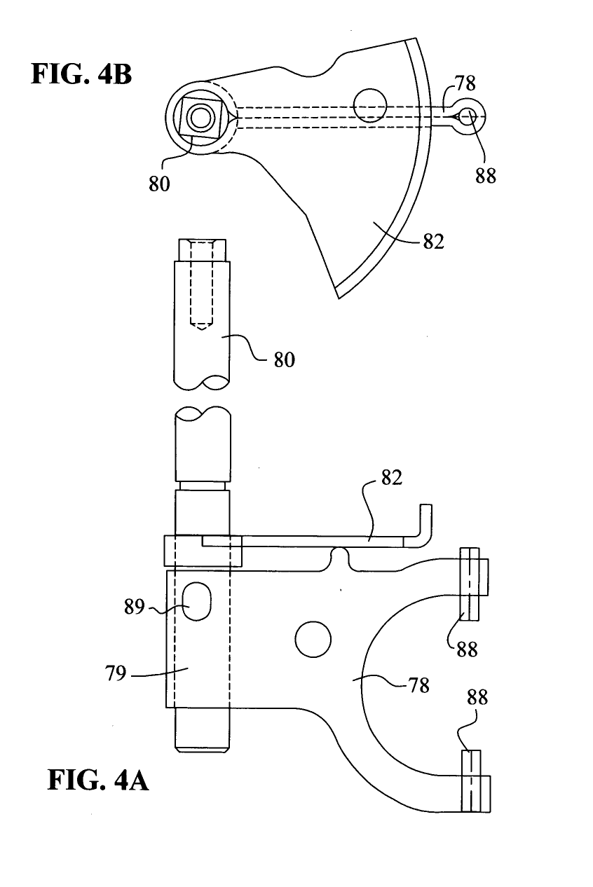

Surrounding shaft 56 and extendable through the forward gears of gear set 54, gear 62 and spacer 64, is sleeve 70 having key 72 disposed thereon and in communication with shift collar 74. Key 72 moves to engage the gear or spacer selected by the operator using manual shift mechanism 33 (FIG. 1) to select one of the reverse, neutral or forward speeds. As can be seen, each gear of gear set 54, gear 62 and spacer 64 is provided a recess 76 in which the tines of key 72 are received to select that particular gear or spacer. Engaged with shift collar 74 is shift fork 78 (FIG. 3B), which is rotatably fixed to shaft 80 (FIGS. 4A and 4B).

Referring now to FIGS. 3B, 4A, and 4B, it can be seen that shift fork 78 and plate 82 share shaft 80. Both shift fork 78 and plate 82 are attached via a known attachment method, such as, for example, brazing or use of a key and keyway, to shaft 80 such that as shaft 80 is rotated both shift fork 78 and plate 82 are rotated as well. Shift fork 78 further includes pins 88 therein for engagement with shift collar 74, such that as shaft 80 and shift fork 78 are rotated, pins 88 which engage shift collar 74 move the tines of key 72 to the selected forward gear of gear set 54, reverse gear 62, or neutral spacer 64.

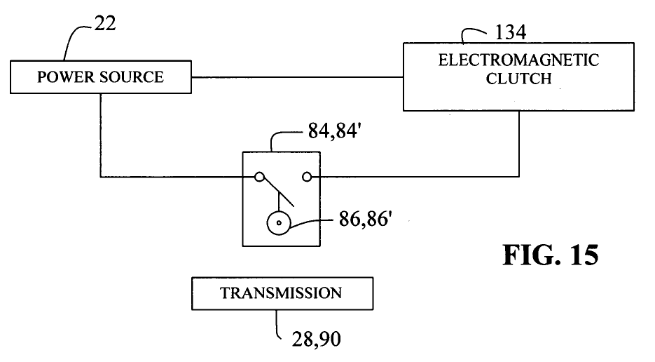

As illustrated in FIGS. 3B and 4A, shift fork 78 includes oblong hole 89 in portion 79 of shift fork 78 surrounding shaft 80. As illustrated in FIG. 3B, switch 84 is mounted proximate shaft 80 in transaxle 28 and includes ball sensor 86 which abuts shift fork 78 such that as shift fork 78 is rotated, ball sensor 86 rides over portion 79 until reaching hole 89. Oblong hole 89 is positioned such that ball sensor 86 will be seated within hole 89 when the operator has selected reverse, or shift fork 78 is moved into a position whereby key 72 will select gear 62. Thus, when the transmission has been shifted into reverse, an electronic signal is not directed by the switch to the electromagnetic clutch associated with mower deck assembly 26, and the mower blades are not operational. At all other times, i.e., when a forward gear of gear set 54 or neutral spacer 64 has been selected, ball sensor 86 is riding on and pressed against the surface of portion 79, and a signal is directed by the switch to the electromagnetic clutch, and mower deck assembly 26 may be operated. When the transmission has been shifted into neutral or forward, switch 84 is closed, thereby causing an electronic circuit between switch 84 and clutch 134 (FIG. 15) to be complete. When transaxle 28 is shifted into reverse and gear 62 is selected, switch 84 is opened, and the circuit is interrupted and mower deck assembly 26 becomes nonoperational. Oblong hole 89 may be replaced with a depression formed in shift fork 79 for the purposes of this document, “depression” is inclusive of a hole

Alternatively, the inventive means may instead comprise a switch which may be in an open position when its sensor is riding on the surface of portion 79, so that a circuit between the switch, and clutch 134 is interrupted and allows operation of mower deck assembly 26. The circuit is complete, or closed, when switch 84 is closed, or the sensor 86 is extending into oblong hole 89.

It is to be noted that although sensor 86 is shown as extending into oblong hole 89 when transmission 28 is shifted into reverse, by adjusting the width of hole 89, sensor 86 may extend into hole 89 when transmission 28 is moved to a forward or neutral position. Again, a circuit between switch 84, sensor 86, and electromagnetic clutch 134 is either completed, or interrupted, dependent upon the position of sensor 86 and whether the circuit is to be used to prevent operation of mower deck assembly 26 or used to allow operation of mower deck assembly 26.

Although transmission 28 is shown has having five forward gears, transmission 28 may alternatively include additional forward gears to provide further options to the operator of mower 20. If a different transmission 28 is utilized, the structure of shift fork 78, plate 82, and shaft 80 may require modifications to accommodate the changes to transmission 28.

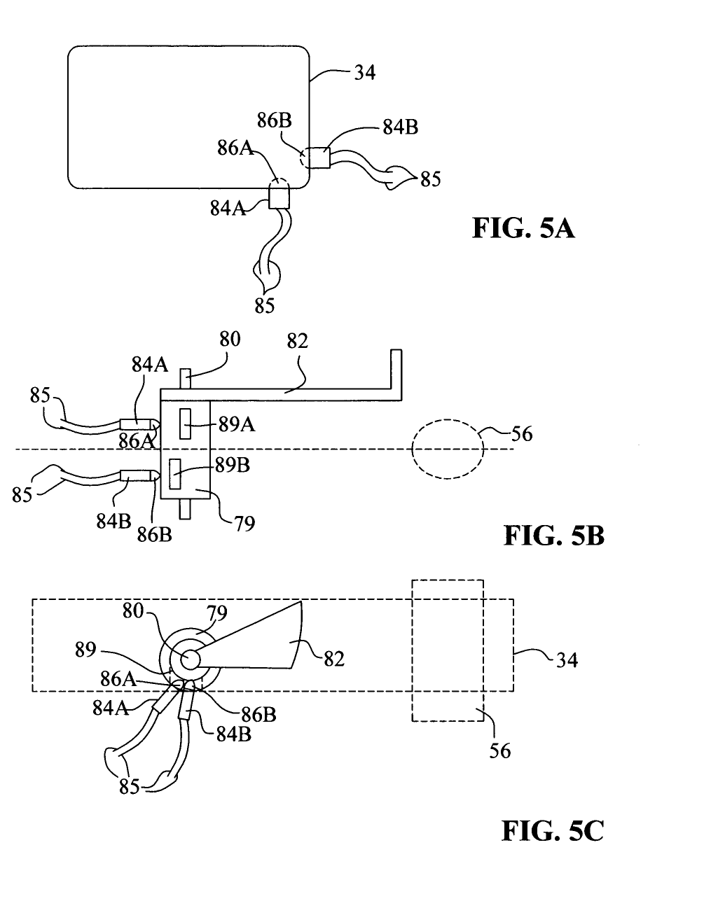

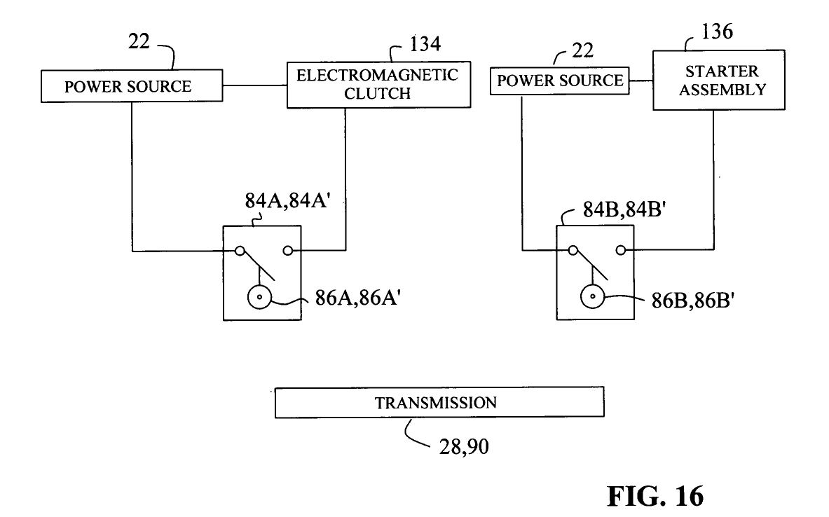

A portion of transmission 28, specifically within upper casing half 34, is schematically illustrated in FIGS. 5A and 5B as including two sensors 86, designated as 86A and 86B, in association with two switches 84, designated as 84A and 84B. Wires 85 extend from switches 84A and 84B for electrical connection to, e.g., an electrical power supply (not shown), such as a battery (not shown) or the magneto (not shown) of engine 22. Included in shift fork portion 79 are two holes 89A and 89B, one for each sensor 86. Through arrangement of holes 89A and 89B, as shown in FIG. 5B, sensor 86A will be seated within hole 89A when shift fork 78 is moved into a reverse position while sensor 86B will be seated in hole 89B when shift fork 78 is moved into the neutral position, thereby providing sensing for both the reverse and neutral positions. One wire 85 of each pair is electrically connected to either electromagnetic clutch 134 or starter mechanism 136 (see FIG. 16), with the other wire of the pair connected to power source 22. With reference to FIG. 5C, an alternative structure of sensors 86A and 86B and switches 84A and 84B is shown in which switches 84A and 84B are arranged in a horizontal side-by-side relationship and a single, larger hole 89 is used in place of holes 89A and 89B for receipt of sensors 86A and 86B.

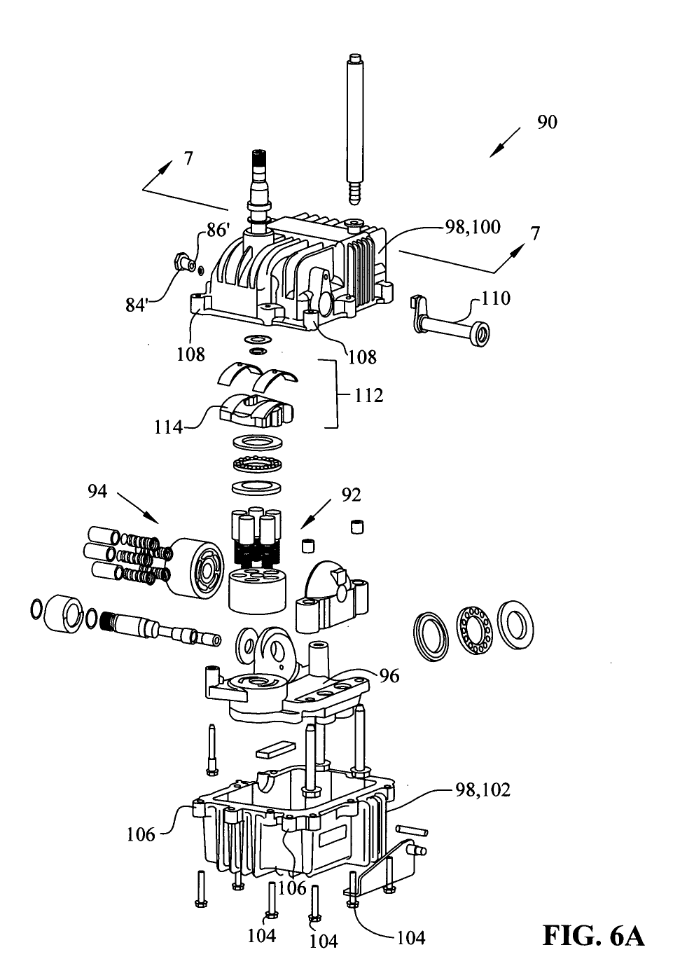

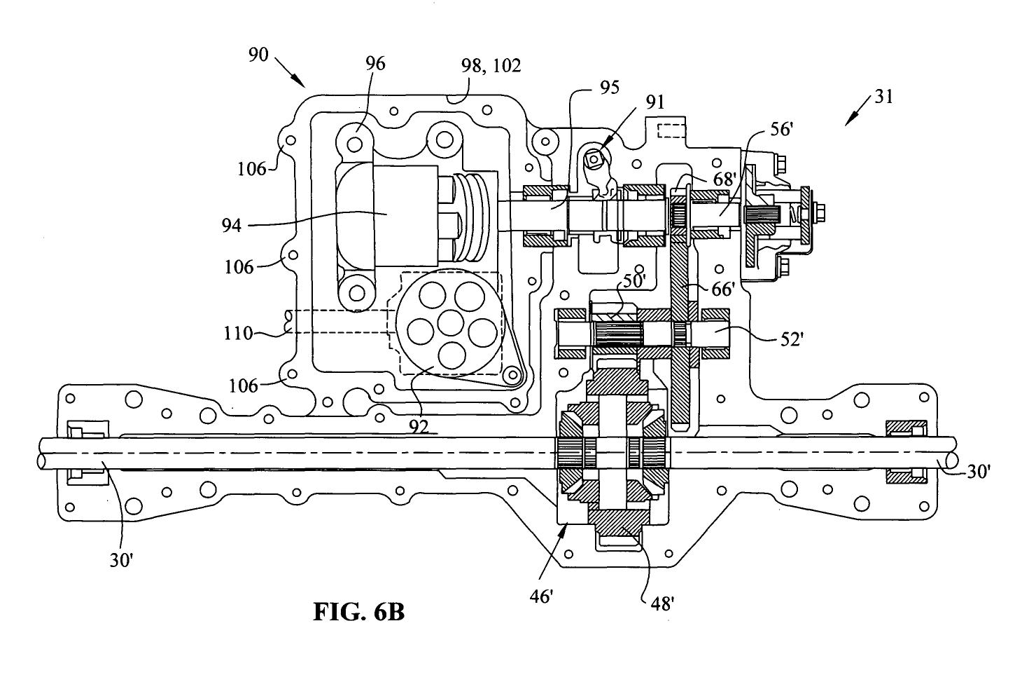

Referring now to FIGS. 6A and 6B, transmission 90 is a hydrostatic transmission such as that disclosed in U.S. Pat. No. 6,422,109, issued Jul. 23, 2002, and assigned to the assignee of the present invention, the complete disclosure of which is expressly incorporated herein by reference. Transmission 90 includes pump 92 and motor 94 mounted on center section 96, all of which are contained within casing 98. Casing 98 includes upper half 100 and lower casing half 102 secured together by bolts 104 extending through apertures in bosses 106 on lower casing half 102 and threaded into threaded apertures in bosses 108 on upper casing half 100.

Transmission 90, specifically variable displacement pump 92, is controlled by control rod 110 in communication with swash plate 114 of swash plate assembly 112. As control rod 110 is rotated, swash plate 114 is pivoted to vary the displacement of fluid pump 92 and control the speed and direction of transmission 90. Transmission 90 is connected to axle assembly 31 (FIG. 6B) to create a transaxle structure for mower 20. Within axle assembly 31, ring gear 48′ of differential 46′ intermeshes with gear 50′ mounted on shaft 52′ to transfer motion to differential 46′ and subsequently to axles 30′. Gear 66′ is mounted on shaft 52′ and intermeshes with small gear 68′ on shaft 56′, which may be piloted to motor output shaft 95 as illustrated. When shafts 95 and 56′ are joined by the collar of disconnect mechanism 91, rotary motion is transferred from transmission 90 to axles 30′ through gears 66′, 68′, and 50′ and differential 46′. The axle assembly, differential, reduction gearing, and mechanical disconnect mechanism are described in further detail in U.S. Pat. No. 6,422,109, incorporated above.

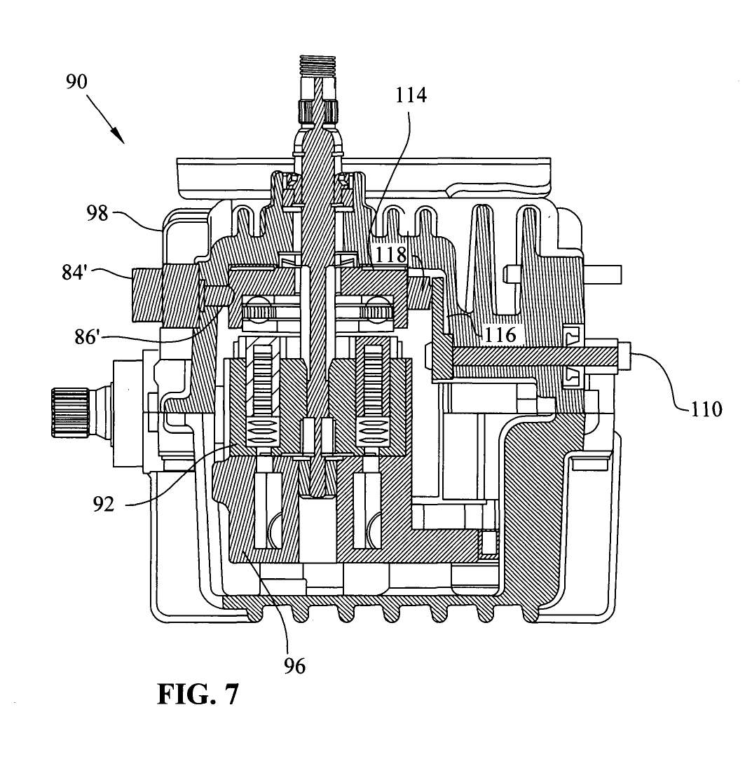

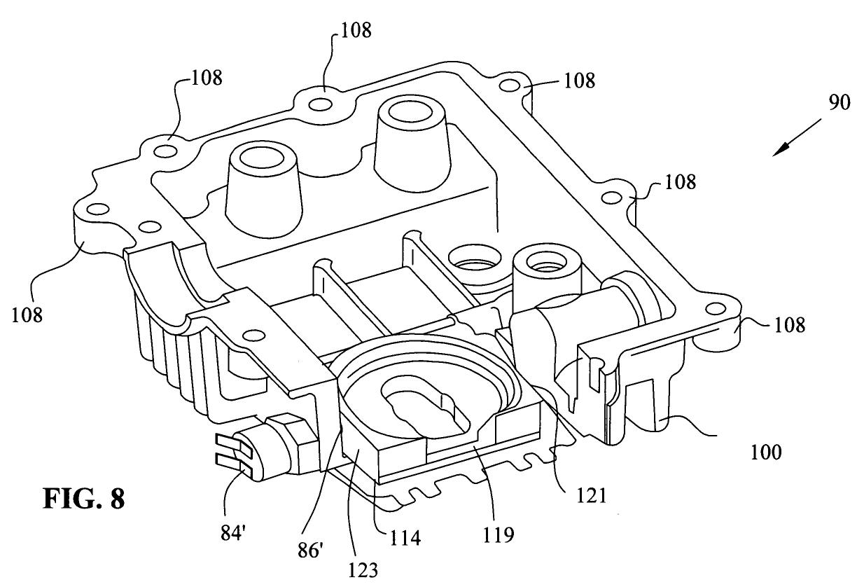

Referring to FIG. 7, in a manner similar to transaxle 28, transmission 90 includes switch 84′ and sensor 86′ mounted on casing 98 and extending into transmission 90. However, where sensor 86 rode along the surface of shift fork 78 of transaxle 28, sensor 86′ instead rides along side 123 of swash plate 114 (FIG. 8) located opposite side 121 which is in contact with control rod 110.

Control rod 110 includes arm 116 and connector 118 for connection to swash plate 114, with the rotation of control arm 110 causing arm 116 and connector 118 to rotate, thereby causing swash plate 114 to pivot and create fluid displacement within pump 92. With reference to FIG. 8 showing the upper half of transmission 90 from the bottom and bottom 119 of swash plate 114, it can be more easily seen that control rod 110, arm 116 and connector 118 would be connected to swash plate 114 on side 121 of swash plate 114 while sensor 86′ would be in abutting engagement with swash plate 114 on opposite side 123 of swash plate 114. The operation of transmission 90 and the movement of swash plate 114 is described in further detail in U.S. Pat. No. 6,422,109, incorporated above.

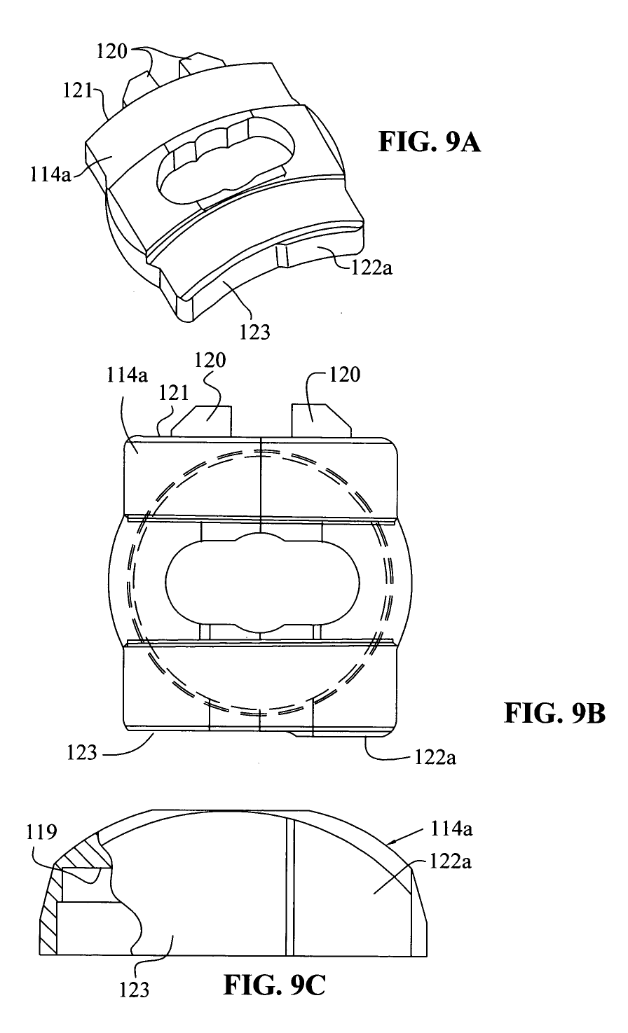

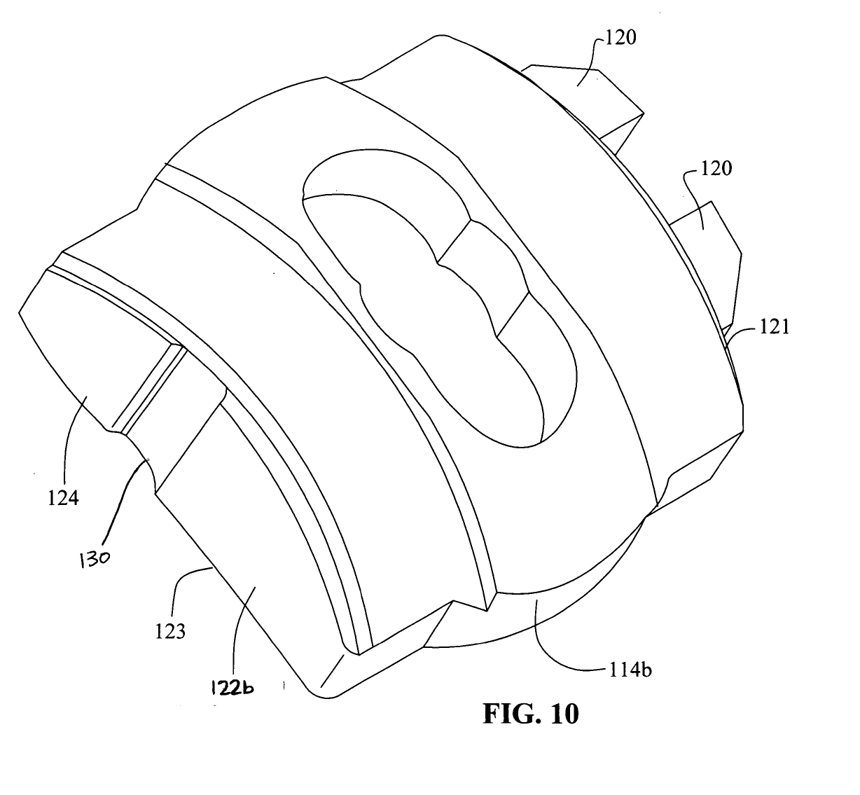

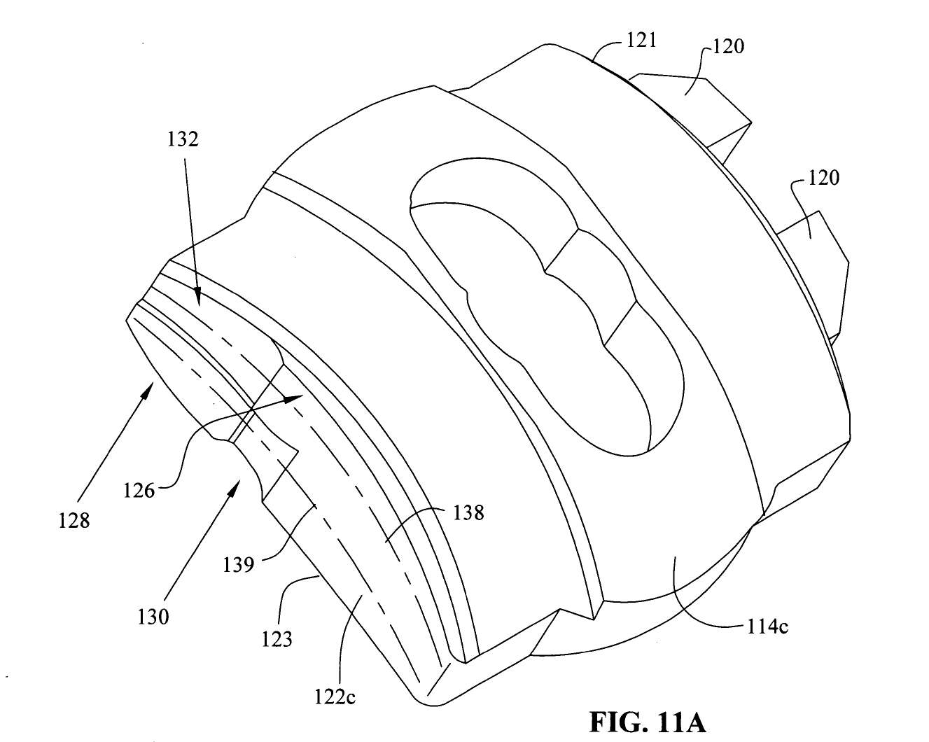

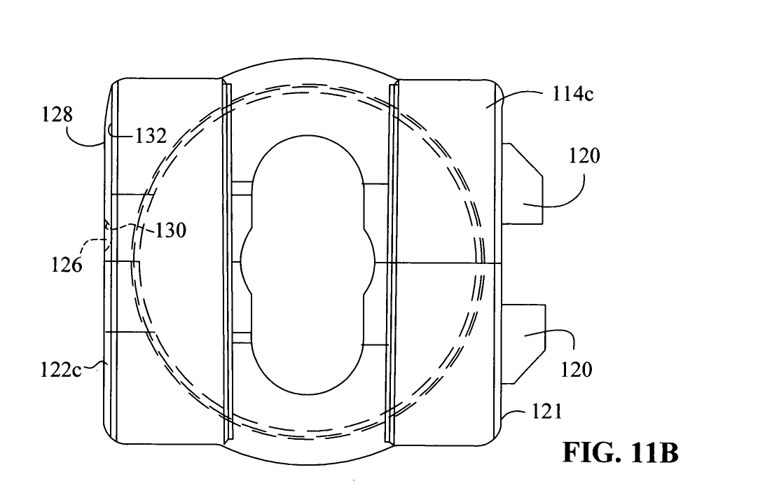

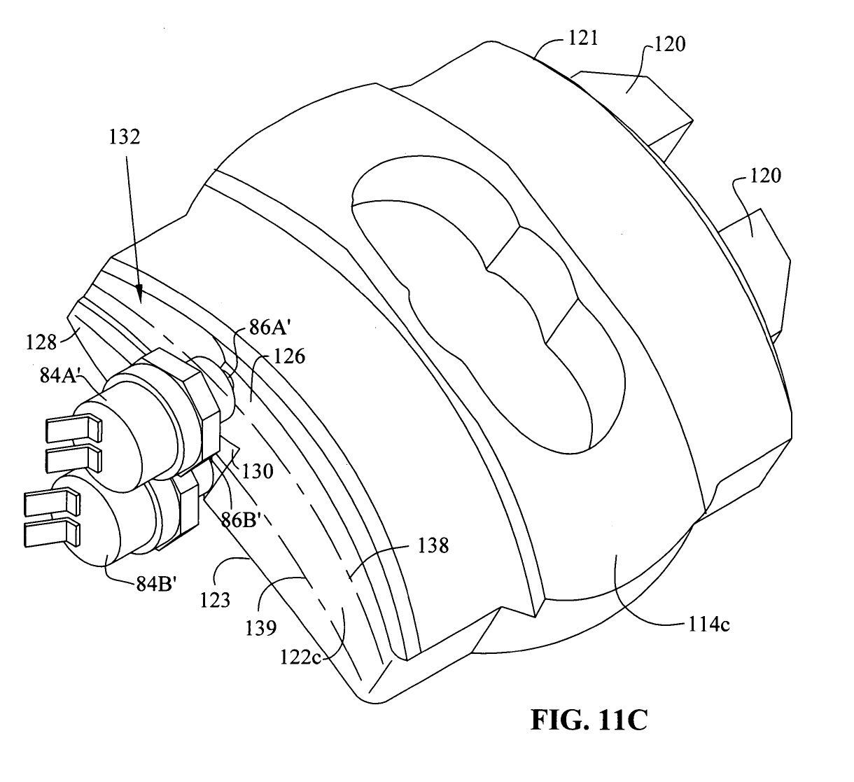

FIGS. 9A, 9B, 9C, 10, 11A, and 11B depict different structures of swash plate 114 with those of FIGS. 9A, 9B, and 9C being for reverse sensing only, the structure of FIG. 10 for neutral sensing only, and the structures in FIGS. 11A and 11B being for a combination of reverse and neutral sensing; all three structures would be operated in the manner as described above.

On one side of swash plate 114a, shown in FIGS. 9A, 9B, and 9C, are two extending portions 120 which will receive connector 118 therebetween for control of movement of swash plate 114a; such extending portions 120 are common to all three swash plate structures. On opposite side 123 of swash plate 114a is a single raised area 122a which depresses sensor 86′ when swash plate 114a is rotated into either a neutral or a forward position. The portion of swash plate 114a not having raised area 122a is the portion of the swash plate along which ball sensor 86′ would ride when swash plate 114a is rotated into the reverse position. In this position, sensor 86′ would not be depressed inwardly.

Referring now to FIG. 10, swash plate 114b has been modified from swash plate 114a and is disclosed in further detail in U.S. Pat. No. 6,378,300, issued Apr. 30, 2002, and assigned to the assignee of the present invention, the complete disclosure of which is expressly incorporated herein by reference. Swash plate 114b includes extending portions 120, as with swash plate 114a, but instead of a single raised area has two raised areas, raised area 122b and secondary raised area 124. Raised area 122b covers that portion of swash plate 114b which would be in an abutting relationship with ball sensor 86′ when in the forward position only. Raised area 124 represents the area of swash plate 114b that would be in an abutting relationship with ball sensor 86′ when rotated to the reverse position. It is to be noted that both raised areas 122b and 124 have the same lateral level, whereas area 130 located on side 123 between raised areas 122b and 124 has a reduced lateral level to form a recess in the form of a groove in side 123. Thus, swash plate 114b of FIG. 10 is used for neutral sensing only, since that portion of the swash plate not having either raised area 122b or 124 represents the zero displacement of swash plate 114b, or when transmission 90 has been shifted into the neutral position.

FIGS. 11A and 11B show third embodiment swash plate 114c that is used for both neutral sensing and reverse sensing. Swash plate 114c has several raised portions, including raised area 122c similar to raised area 122b (FIG. 10) and which represents that area of swash plate 114c that would be in abutting engagement with ball sensor 86′ when in the forward position. Unlike swash plates 114a and 114b, swash plate 114c further includes laterally raised areas 126 and 128 and two slightly depressed areas 130 and 132. Laterally raised area 126 extends from raised area 122c and is positioned on swash plate 114c in a portion of the area which represents the neutral area of swash plate 114c, or the non-raised area of swash plate 114b if compared thereto. Laterally raised area 128 is positioned in a portion of the area of swash plate 114c which would abut sensor 86′ if a single sensor 86′ were used for reverse sensing only, or the non-raised area of comparable swash plate 114a. In other words, swash plates 114a and 114b have been combined to a certain extent to create swash plate 114c which interacts with two sensors 86′, designated as 86A′ and 86B′ for sensing of neutral and reverse (FIG. 11C). As stated, two sensors 86A′ and 86B′, and thereby two switches 84A′ and 84B′, would be used in conjunction with swash plate 114c with sensor 86A′ mounted such that it senses the reverse position of the swash plate, or sensor 86A′ would follow arc 138 as swash plate 114c is rotated, while sensor 86B′ senses the neutral position, or sensor 86B′ would follow arc 139. Ball sensor 86A′ would be sensing for whether it is abutting laterally raised areas 122 or 126 or extending to touch area 132, while second sensor 86B′ would be sensing for laterally raised areas 122 or 128 or extending to area 130.

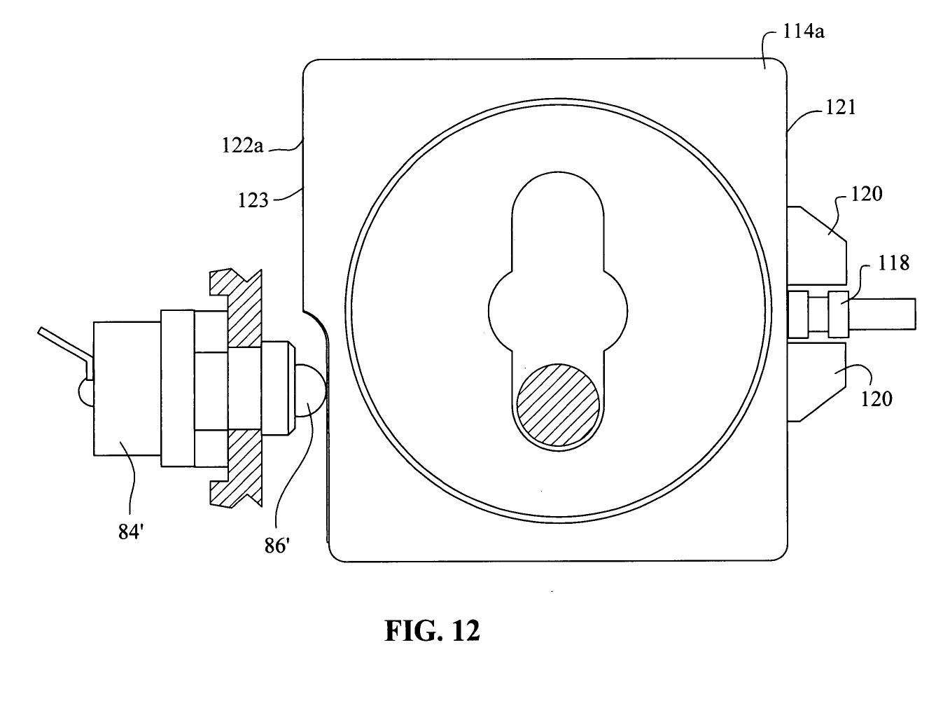

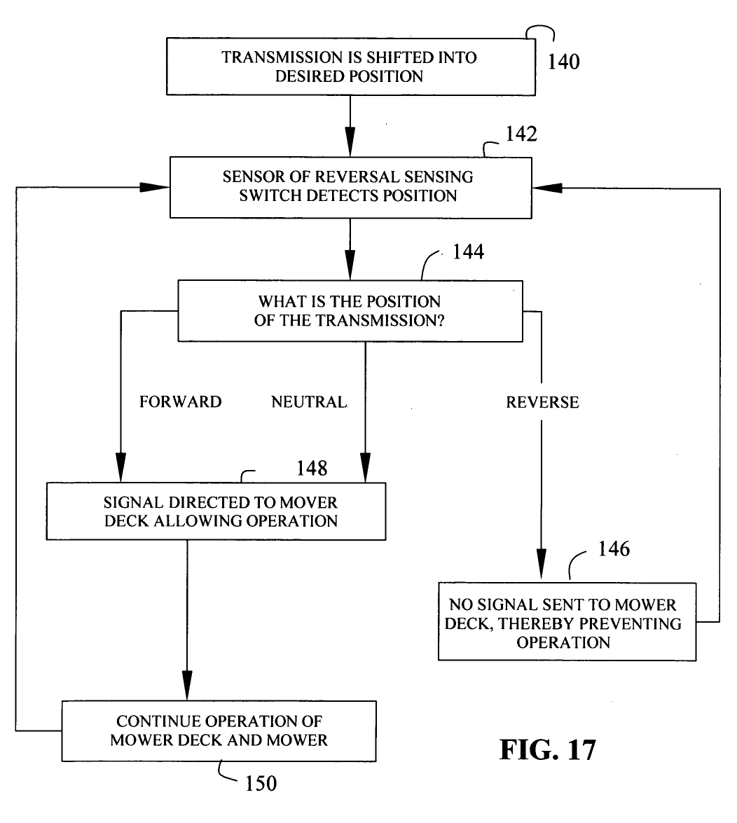

Referring to FIGS. 12, 13, 14, and 17, the operation of the ball sensor 86′ with switch 84′ will be described with reference to a reverse sensing mechanism only. As shown in FIGS. 12 and 17, swash plate 114a has been rotated into the position desired by the operator at the time, (block 140), in this case the reverse position. Ball sensor 86′ is not pressed inwardly by any raised portions on swash plate 114a but rather extends outwardly, thus allowing ball sensor 86 to detect the reverse position (blocks 142 and 144). Since ball sensor 86′ is not pushed inwardly, the electrical connection is not complete and no electronic signal is sent from switch 84′ (block 146), thereby preventing electromagnetic clutch 134, which controls the mower deck assembly 26, from being operational.

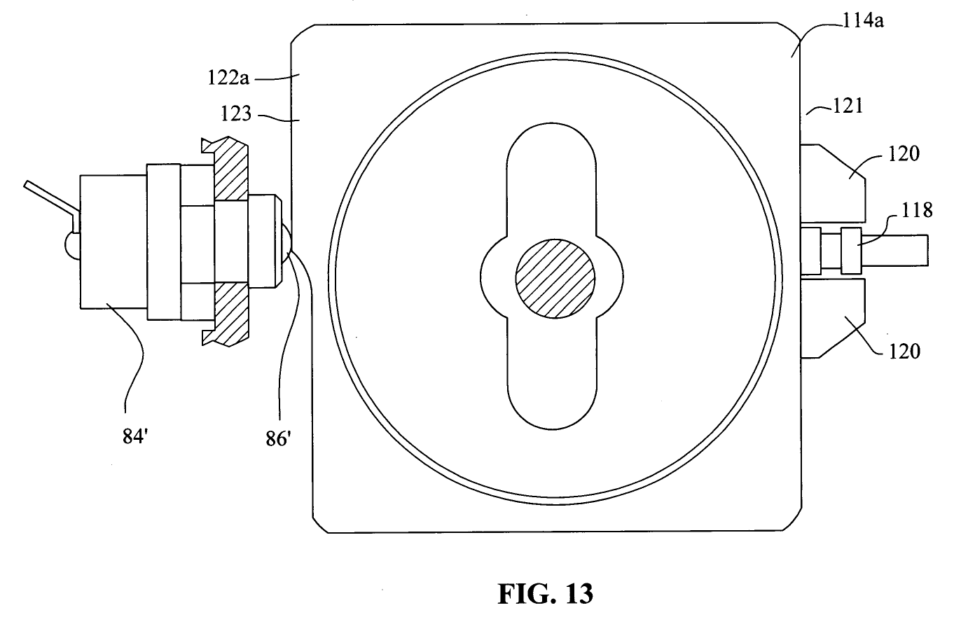

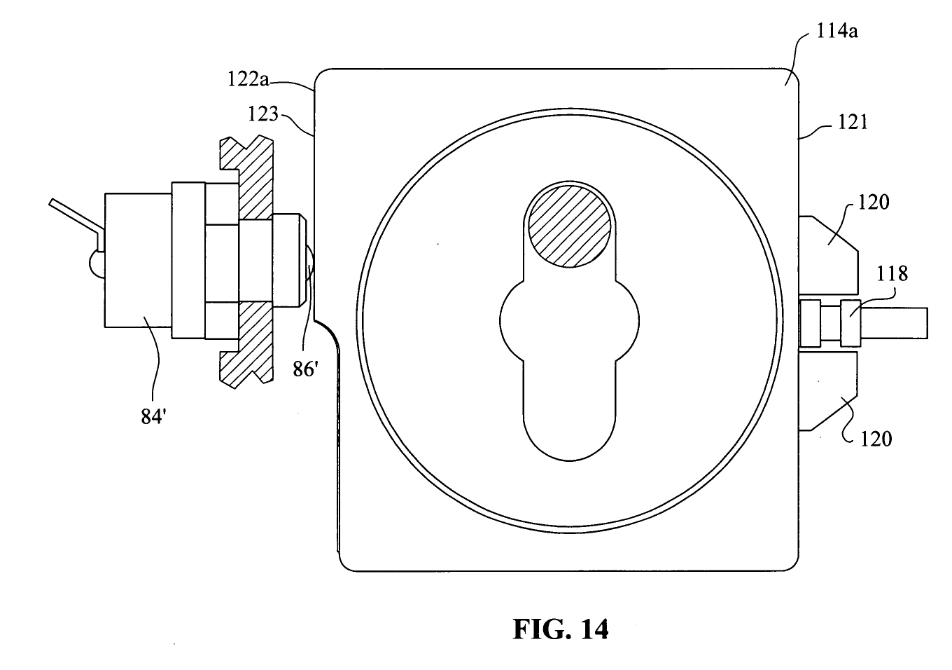

As shown in FIGS. 13, ball sensor 86′ is pressed inwardly as it reaches the edge of raised area 122a,when transmission 90 is shifted into the desired neutral position (block 140). Since the ball sensor 86′ is pushed inwardly and a neutral position is sensed (blocks 142 and 144), the electrical circuit is closed, and thus an electronic signal is sent as directed by switch 84′ (block 148) allowing operation of mower deck assembly 26. Since mower deck assembly 26 is operational, the user may continue operation of the deck and mower (block 150). Lastly, with reference to FIG. 14, swash plate 114a has been rotated to a forward position (block 140) and ball sensor 86′ is pushed inwardly by raised area 122a to detect a forward position (blocks 142 and 144) resulting in the electric circuit being closed with a signal being sent, again as directed by switch 84′ (block 148), thereby allowing full and continued operation of mower deck assembly 26 (block 150).

Although the operation of switch 84′ and sensor 86′ has been described with respect to reverse sensing only, in those situations where switch 84′ and ball sensor 86′ would be sensing for neutral only, the general operation would be similar in terms of a signal being sent when ball sensor 86′ is pushed inwardly, or when swash plate 114b has been rotated into a forward or a reverse position. Likewise, in those situations where two such switches 84′ are used, or both reverse and neutral are being sensed, the general operation would be similar in that a signal is sent from switches 84′ when a respective sensor 86′ is pushed inwardly. In operation, the reverse sensing and neutral sensing structure would be a combination of both systems described above. The sensor 86′ being used to sense reverse would be pushed inwardly in both the forward and neutral positions as described with reference to FIGS. 12 through 14. The ball sensor 86′ being used to sense neutral would be pushed inwardly in the forward and reverse positions with the appropriate signals being sent by the corresponding switches 84′.

As described with reference to manual shift transmission 28, alternative structures of the reverse sensing may be utilized. For example, rather than having the forward and neutral positions in raised area 122a,the reverse position may be raised. Likewise, similar alternatives, that is the raised areas being flattened and the currently flattened areas raised, may be constructed for the neutral sensing only and the reverse and neutral sensing swash plates, or swash plates 114b and 114c.

Also, in a manner similar to that described relative to manual shift transmission 28, switch 84′ may be structured to be open when forward and neutral are sensed, and closed when reverse is sensed, thus causing the signal to be sent to prevent operation of mower deck assembly 26. The circuits associated with the neutral sensing only and the reverse and neutral sensing systems may likewise be structured to send signals to prevent operation rather than sending signals to allow operation.

Referring to FIG. 15, a schematic circuit diagram is shown with electromagnetic clutch 134 being in electrical communication with switch 84, 84′ and ball sensor 86, 86′. As can be seen, ball sensor 86, 86′ may be in communication with either transaxle 28 or transmission 90 such that when the reverse position is sensed, ball sensor 86, 86′ moves outwardly, thereby breaking the circuit between switch 84, 84′ and clutch 134 and interrupting any electronic signal that could be sent to electromagnetic clutch 134 by switch 84, 84′. Referring to FIG. 16, two such sensors 86A and 86B and 86A′ and 86B′, and switches 84A and 84B and 84A′ and 84B′ are shown. Sensors 86A and 86A′ are electronically connected to electromagnetic clutch 134 and are used to sense the reverse position of transmission 90, while sensors 86A and 86B′ are used to sense the neutral position and are connected to starter mechanism 136 of mower 20. Thus, if reverse is sensed by reverse sensing ball sensor 86A, 86A′ then that circuit with electromagnetic clutch 134 is broken, whereas if neutral is sensed by the neutral sensing ball sensor 86B, 86B′, then the circuit with starter mechanism 136 is broken and no signals are sent to the respective units.

By using electronic sensors 86, 86′ for determination of the position of the transmission 28, 90, continuous sensing may occur. Thus, when the operator returns the transmission to a neutral or forward position from a reverse position, such movement may be sensed and the mower deck assembly allowed to operate again without a need to shut down and restart the mower or other complicated procedures. Furthermore, only minor modifications to the shift fork 78, 78′, swash plates 114, and the respective transmission casings are required for implementation of the sensing systems. Thus, the sensing systems may be incorporated into existing transmission designs without extensive retooling and redesign by the manufacturers. Additionally, since all sensing is done as the operator operates the mower, the operator does not need to perform contorted maneuvers to safely operate the mower and to disengage the mower blades when the transmission is shifted into reverse.

While this invention has been described as having exemplary structures, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An axial piston hydrostatic transmission, comprising:
a variable displacement axial piston pump;
an input shaft rotatably connected to said pump, whereby rotation of said input shaft causes rotation of said pump;
an axial piston motor hydraulically connected to said pump;
an output shaft roatably connected to said motor, whereby rotation of said motor causes rotation of said output shaft;
a pivotable swash plate associated with said pump, whereby movement of said swash plate controls the speed and direction of the hydrostatic transmission, said swash plate movable between a forward position, a neutral position, and a reverse position;
a sensor adjacent said swash plate, said sensor operable to sense the position of said swash plate; and
a switch connected to said sensor, said switch moveable between a closed position and an open position in response to said sensor.

2. The axial piston hydrostatic transmission of claim 1, wherein said swash plate includes an exterior surface, said sensor abutting said exterior surface, said exterior surface having a raised area, whereby movement of said swash plate places said sensor in and out of abutting relationship with said raised area, and whereby when said sensor is in abutting relationship with said raised area, said switch is in one of said open and said closed positions, and when said sensor is not in abutting relationship with said raised area, said switch is in the other of said open and said closed positions.

3. The axial piston hydrostatic transmission of claim 1, wherein said swash plate includes an exterior surface, said sensor abutting said exterior surface, said exterior surface having a depression, whereby movement of said swash plate positions said sensor in and out of said depression, and whereby when said sensor is in said depression said switch is in one of said open and said closed positions, and when said sensor is not in said depression said switch is in the other of said open and said closed positions.

4. A gear transmission, comprising:
a plurality of mechanically selectable forward gears;
a mechanically selectable reverse gear;
a neutral spacer;
a shift key for selectively engaging one of said plurality of forward gears and said reverse gear;
a shift fork connected to said shift key, whereby movement of said shift fork causes movement of said shift key to control the speed and direction of the transmission, said shift fork movable between a forward position, a neutral position, and a reverse position;
a sensor adjacent said shift fork, said sensor operable to sense the position of said shift fork; and
a switch connected to said sensor, said switch moveable between a closed position and an open position in response to said sensor.

5. The gear transmission of claim 4, wherein said shift fork includes an exterior surface, said sensor abutting said exterior surface, said exterior surface having a depression, whereby movement of said shift fork places said sensor in and out of said depression, and whereby when said sensor is in said depression said switch is in one of said open and said closed positions, and when said sensor is not in said depression said switch is in the other of said open and said closed positions.

6. A lawnmower comprising:
a frame;
an engine having an electrical system and attached to said frame;
a starter mechanism connected to said engine for starting said engine;
a mower deck assembly having a rotatable blade connected to said frame, said blade selectively engaged with said engine;
an axial piston hydrostatic transmission, comprising:
a variable displacement axial piston pump;
an input shaft rotatably connected to said pump, whereby rotation of said input shaft causes rotation of said pump, said input shaft operably connected to said engine;
an axial piston motor hydraulically connected to said pump;
an output shaft rotatably connected to said motor, whereby rotation of said motor causes rotation of said output shaft;
a pivotable swash plate associated with said pump, whereby movement of said swash plate controls the speed and direction of the hydrostatic transmission, said swash plate movable between a forward position, a neutral position, and a reverse position;
a sensor adjacent said swash plate, said sensor operable to sense the position of said swash plate; and
a switch connected to said sensor, said switch movable between a closed position and an open position in response to said sensor.

7. The lawnmower of claim 6, wherein said swash plate includes an exterior surface, said sensor abutting said exterior surface, said exterior surface having a raised area, whereby movement of said swash plate places said sensor in and out of abutting relationship with said raised area, and whereby when said sensor is abutting relationship with said raised area said switch is in one of said open and said closed positions, and when said sensor is not in abutting relationship with said raised area said switch is in the other of said open and said closed positions.

8. The lawnmower of claim 6, wherein said swash plate includes an exterior surface, said sensor abutting said exterior surface, said exterior surface having a depression, whereby movement of said swash plate places said sensor in and out of abutting relationship with said depression, and whereby when said sensor is in abutting relationship with said depression said switch is in one of said open and said closed positions, and when said sensor is not in abutting relationship with said depression said switch is in the other of said open and said closed positions.

9. The lawnmower of claim 6, further comprising:
a second sensor adjacent said swash plate, said second sensor operable to sense the position of the swash plate; and
a second switch connected to said second sensor, said second switch movable between a closed position and an open position in response to said second sensor, said first sensor in electrical communication with said starter circuit, said second sensor in electrical communication with said mower deck assembly, said first sensor operable to disable said starter circuit when the swash plate is in either the forward or the reverse position, said second senor operable to disengage said rotatable blade from said engine when said swash plate is in the reverse position.

10. A lawnmower comprising:
a frame;
an engine having an electrical system and attached to said frame;
a starter mechanism connected t said engine for starting said engine;
a mower deck assembly having a rotatable blade connected to said frame, said blade selectively engaged with said engine;
a gear transmission, comprising:
a plurality of mechanically selectable forward gears;
a mechanically selectable reverse gear;
a neutral spacer;
a shift key for selectively engaging one of said plurality of forward gears and said reverse gear;
a shift fork connected to said shift key, whereby movement of said shift fork causes movement of said shift key to control the speed and direction of the transmission, said shift fork movable between a forward position, a neutral position, and a reverse position;
a sensor adjacent said shift fork, said sensor operable to sense the position of said shift fork; and
a switch connected to said sensor, said switch movable between a closed position and an open position in response to said sensor.

11. The gear transmission of claim 10, wherein said shift fork includes an exterior surface, said sensor abutting said exterior surface, said exterior surface having a depression, whereby movement of said shift fork places said sensor in and out of said depression, and whereby when said sensor is in said depression said switch is in one of said open and said closed positions, and when said sensor is not in said depression said switch is in the other of said open and said closed positions.

12. The lawnmower of claim 10, further comprising;
a second sensor adjacent said shift fork, said sensor operable to sense the position of said shift fork; and
a second switch connected to said second sensor, said second switch movable between a closed position and an open position in response to said sensor, said first sensor in electrical communication with said starter circuit, said second sensor in electrical communication with said mower deck assembly, said first sensor operable to disable said starter circuit when the swash plate is in either the forward or the reverse position, said second senor operable to disengage said rotatable blade from said engine when said swash plate is in the reverse position.

13. A sensing and disabling system for a lawn mower to prevent operation of a mower deck assembly while in reverse and to prevent start-up of the mower if not in neutral, the system comprising:
an engine;
a transmission having a selectively entered reverse condition, a selectively entered forward condition, and a selectively entered neutral position, said transmission being selectively driven by said engine;
a mower deck assembly selectively driven by said engine;
a first sensor in communication with said transmission and said mower deck assembly, said first sensor preventing operation of said mower deck assembly when said first sensor senses said transmission is in said reverse condition; and
a second sensor in communication with said transmission and said engine, said second sensor preventing start-up of said engine when said second sensor senses said transmission is in either said forward or said reverse position.

14. The transmission of claim 13, wherein said transmission is a manual shift transmission, said shift mechanism including a shift fork rotatably fixed to a shaft, said first sensor selectively abutting an outer surface of said shift fork, said outer surface of said shift fork including a first hole therein, said first sensor extending into said first hole when said shift mechanism is shifted into its reverse position, whereby said first sensor senses said reverse position, said second sensor selectively abutting said outer surface of said shift fork, said outer surface of said shift fork including a second hole therein, said second sensor extending into said second hole when said shift mechanism is shifted into its said neutral position, whereby said second sensor senses said neutral position.

15. The transmission of claim 13, wherein said transmission is a hydrostatic transmission, said transmission further including a swash plate, said shift mechanism controlling pivotable movement of said swash plate, said first sensor abutting an exterior surface of said swash plate, said swash plate including a raised surface, said first sensor being pushed inwardly and sensing one of said neutral and said forward position when abutting said raised surface, said first sensor sensing said reverse position when not abutting said raised area, said second sensor abutting said exterior surface of said swash plate, said swash plate including a depression, said second sensor being pushed inwardly and sensing one of said forward and said reverse position when positioned outside said depression, said second sensor sensing said neutral position when positioned within said depression .
